(19) United States
(12) Patent Application Publication
(10) Pub. No.: US 2026/0100467 A1
(43) Pub. Date: Apr. 9, 2026

(54) BATTERY ASSEMBLY

(71) Applicant: Schaeffler Technologies AG & Co. KG, Herzogenaurach (DE)

(72) Inventors: Paul Lindemann, Howard, OH (US); Rashid Farahati, Copley, OH (US)

(73) Assignee: Schaeffler Technologies AG & Co. KG, Herzogenaurach (DE)

(21) Appl. No.: 19/089,648

(22) Filed: Mar. 25, 2025

Related U.S. Application Data
(60) Provisional application No. 63/704,070, filed on Oct. 7, 2024.

(51) Int. Cl. H01M 50/264; H01M 10/04

(52) U.S. Cl. CPC H01M 50/264; H01M 10/0481

(57) ABSTRACT

A battery assembly includes a first endplate, a second endplate, at least one cell stack disposed between the first endplate and the second endplate, at least one compression spring disposed between the first endplate and the second endplate and configured to bias the at least one cell stack toward the second endplate, and a belt operably coupled with and extending between the first endplate and the second endplate. The belt is configured to bias the second endplate toward the first endplate.

### CROSS-REFERENCE TO RELATED APPLICATIONS

This application claims priority to U.S. 63/704,070, filed on Oct. 7, 2024, entitled “SOLID STATE BATTERY PACK,” the disclosure of which is hereby incorporated herein by reference in its entirety.

### FIELD OF THE DISCLOSURE

The present disclosure generally relates to battery assemblies. More specifically, the present disclosure relates to cell stack height management for a battery assembly.

### BACKGROUND OF THE DISCLOSURE

Solid state battery cells are known.

### SUMMARY OF THE DISCLOSURE

According to a first aspect of the present disclosure, a battery assembly includes a first endplate, a second endplate, at least one cell stack disposed between the first endplate and the second endplate, at least one compression spring disposed between the first endplate and the second endplate and configured to bias the at least one cell stack toward the second endplate, and a belt operably coupled with and extending between the first endplate and the second endplate. The belt is configured to bias the second endplate toward the first endplate.

Embodiments of the first aspect of the disclosure can include any one or a combination of the following features:
the at least one cell stack includes a plurality of cells stacked together forming a height of the at least one cell stack, wherein the belt includes a first straight portion, a second straight portion opposite the first straight portion, a first bend portion between the straight portions and extending around the first endplate, and a second bend portion between the straight portions and extending around the second endplate, wherein the belt is in tension to squeeze the at least one compression spring and the at least one cell stack together;
the first endplate includes a body having an outer surface at least a portion of which contacts the belt to form the first bend portion around the body, at least a portion of the first bend portion extending at an oblique angle relative to the first straight portion;
the outer surface forms an arcuate surface engaged by the belt forming an arcuate shape of the first bend portion;
the first endplate defines a passage forming at least a portion of the arcuate surface recessed therein;
the arcuate surface extends from a first side of the body engaged by the first straight portion to a second side of the body engaged by the second straight portion;
at least one retention plate disposed between the at least one cell stack and the at least one compression spring, the at least one retention plate configured to laterally align the at least one compression spring;
the at least one retention plate includes a first retention plate and a second retention plate that sandwich the at least one compression spring;
the at least one compression spring includes a plurality of compression springs disposed in a space defined between the first retention plate and the second retention plate, wherein the plurality of compression springs are laterally offset from one another;
the at least one cell stack includes a first cell stack interposing the first endplate and the first retention plate and a second cell stack interposing the second endplate and the second retention plate; and
the at least one retention plate defines a groove configured to receive the at least one compression spring.

According to a second aspect of the present disclosure, a battery assembly includes a first endplate, a second endplate, at least one cell stack disposed between the first endplate and the second endplate, at least one compression spring disposed between the first endplate and the second endplate and configured to bias the at least one cell stack toward the second endplate, and a retention plate disposed between the at least one cell stack and the at least one compression spring. The retention plate is configured to align the at least one compression spring. A belt is operably coupled with and extends between the first endplate and the second endplate. The belt is configured to bias the second endplate toward the first endplate.
the at least one cell stack includes a plurality of cells stacked together forming a height of the at least one cell stack, wherein the belt includes a first straight portion, a second straight portion opposite the first straight portion, a first bend portion between the straight portions and extending around the first endplate, and a second bend portion between the straight portions and extending around the second endplate, wherein the belt is in tension to squeeze the at least one compression spring and the at least one cell stack together;
the first endplate includes a body having an outer surface at least a portion of which contacts the belt to form the first bend portion around the body, at least a portion of the bend extending at an oblique angle relative to the first straight portion;
the portion of the outer surface defines an arcuate surface engaged by the belts forming an arcuate shape of the first bend portion; and
the at least one cell stack includes a first cell stack interposing the first endplate and the retention plate.

According to a third aspect of the present disclosure, a battery assembly includes first and second endplates, a plurality of battery cells stacked between the first and second endplates, at least one compression spring disposed within the plurality of battery cells, and a tension belt system wrapped around the first and second endplates.
spring retention plates distributed within the plurality of battery cells, wherein the at least one compression spring is disposed between two of the spring retention plates;
the endplates are curved; and
compliant material is slotted between a pair of the plurality of battery cells.

These and other features, advantages, and objects of the present disclosure will be further understood and appreciated by those skilled in the art by reference to the following specification, claims, and appended drawings.

### BRIEF DESCRIPTION OF THE DRAWINGS

The present disclosure is described below by reference to the following drawings, in which:

FIG. 1 is a perspective view of a battery assembly;

FIG. 2 is a cut-away view of the battery assembly of FIG. 1 taken along the plane II-II; and

FIG. 3 is a cut-away view of the battery assembly of FIG. 1 taken along the plane III-III.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body 38 with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

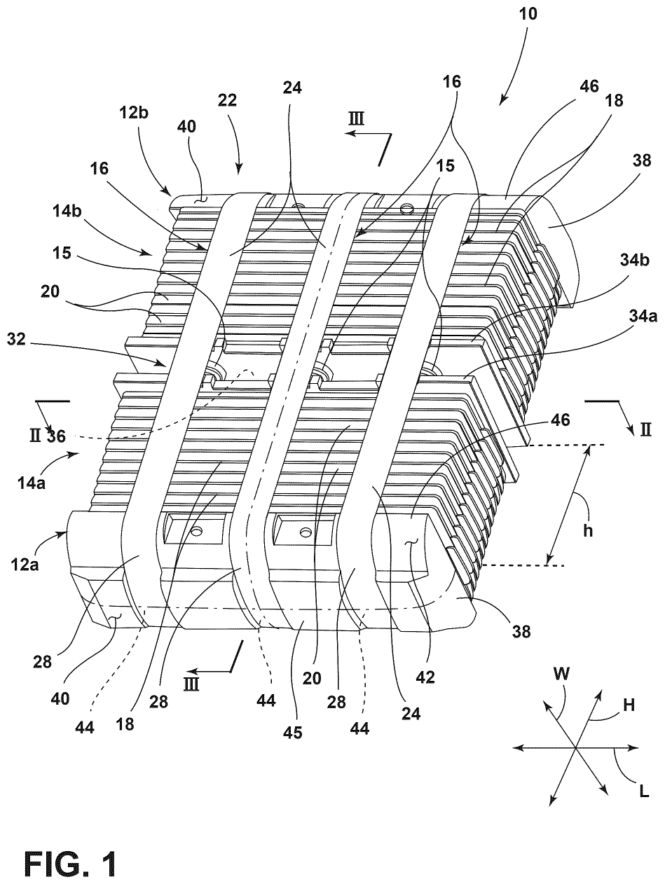

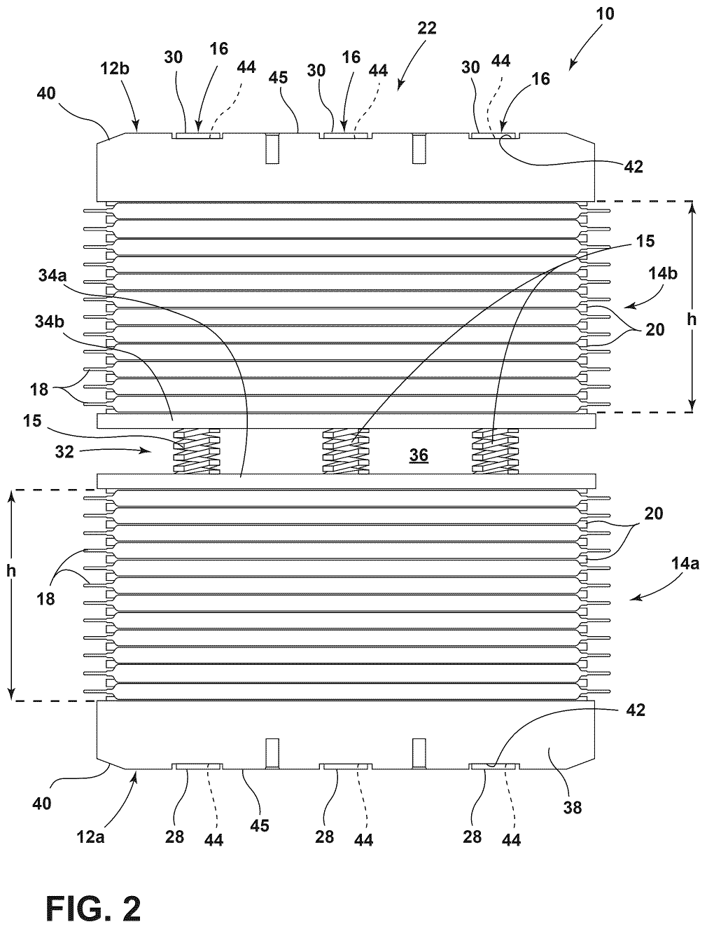

Referring to FIGS. 1-3, a battery assembly is generally indicated at 10. The battery assembly 10 includes a first endplate 12a, a second endplate 12b, and at least one cell stack 14a, 14b disposed between the first endplate 12a and the second endplate 12b. At least one compression spring 15 is disposed between the first endplate 12a and the second endplate 12b and is configured to bias the at least one cell stack 14a, 14b toward the second endplate 12b. A belt 16 operably couples with and extends between the first endplate 12a and the second endplate 12b. The belt 16 is configured to bias the second endplate 12b toward the first endplate 12a.

The battery assembly 10 can include a battery pack for use in a vehicular environment. For example, the battery pack can be configured to provide electrical power for one or more components of a vehicle. The at least one cell stack 14a, 14b can include one cell stack or a plurality of cell stacks 14a, 14b distributed between the first endplate 12a and the second endplate 12b. Each stack 14a, 14b can include a plurality of cells 18 arranged sequentially to define a height of the stack 14a, 14b (stack height h). Compliant material 20 can be slotted between each pair of subsequent cells 18 to allow for uniformity of the cell stacks 14a, 14b. The compliant material 20 can provide contact between the cells 18 of the cell stack 14, 14b during this variance. For example, the cells 18 can swell during charging or discharging thereby causing the stack height h to vary. In some examples, the battery assembly 10 incorporates thermal control via heating mats or cooling loops are also slotted between cell stacks 14, 14b depending on desired operation conditions.

The cells 18 can be electrochemical cells, such as battery cells, having a cathode, an anode, and an electrolyte layer disposed therebetween for conducting ions between the cathode and the anode. One or more of the cells 18 can be solid-state batteries that utilize a solid electrolyte layer. In some examples, the liquid or gel electrolyte layers are incorporated in the battery assembly 10. The sequential arrangement of the plurality of cells 18 can be a stacking of a first cathode-electrolyte-anode battery adjacent a second cathode-electrolyte-anode battery.

With continued reference to FIGS. 1-3, the battery assembly 10 can have a height H extending in a first direction along a shortest distance between the pair of endplates 12a, 12b, a length L orthogonal to the height H and extending laterally in a second direction, and a width W orthogonal to the height H and the length and extending laterally in a third direction orthogonal to the first direction and the second direction. A tension belt system 22 wraps around the first endplate 12a and the second endplate 12b to minimize bending stress. The tension belt system 22 can apply between 0-2 Megapascals (MPa) of contact pressure through each cell stack 14a, 14b. The tension belt system 22 can include one or more belts 16 that can tension the first and second endplates 12a, 12b toward one another. Each belt 16 includes a first straight portion 24, a second straight portion 26 opposite the first straight portion 24, a first bend portion 28 between the straight portions 24, 26 and extending around the first endplate 12a, and a second bend portion 30 between the straight portions 24, 26 and extending around the second endplate 12b. One or more of the belts 16 can bias the first endplate 12a toward the second endplate 12b, and vice versa. For example, the belts 16 can be in tension to squeeze the at least one compression spring 15 and the at least one cell stack 14a, 14b together. In the present example, the straight portions extend along the height. The tension system can assist in maintaining contact between adjacent cells 18 of the cell stacks 14, 14b.

In the illustrated example, a first cell stack 14a and a second cell stack 14b are provided between the endplates 12a, 12b. A compression assembly 32 that includes the at least one compression spring 15 is disposed between the first cell stack 14a and the second cell stack 14b. The plurality of cell stacks 14a, 14b can include any number of cell stacks and/or that multiple compression assemblies can be provided between a given pair of the plurality of cell stacks 14a, 14b. Additionally, or alternatively, a compression assembly 32 can directly interpose one of the endplates 12a, 12b and a cell stack 14a, 14b. In the present example, the compression assembly 32 is sandwiched between the first cell stack 14a and the second cell stack 14b, which may allow for swelling of the cell stacks 14a, 14b while keeping end points stationary.

The compression assembly 32 can provide for displacement during charge/discharge cycles of the cell stacks 14a, 14b. For example, the compression assembly 32 can allow for 30% expansion of the cell stacks 14a, 14b that can occur during charging.

With continued reference to FIGS. 1-3, the compression assembly 32 can include a pair of retention plates 34a, 34b each having a rectangular shape. The pair of retention plates 34a, 34b define a space 36 extending therebetween and in which the at least one compression spring 15 is disposed. The compression assembly 32 can include a plurality of compression springs 15 distributed laterally within the space 36. For example, the compression springs 15 can be evenly or unevenly distributed along the width W and length L in the space 36.

Still referring to FIGS. 1-3, each endplate 12a, 12b can include a body 38 having an outer surface 40 at least a portion of which contacts a belt 16 to form the bend portions 28, 30 around the body 38. At least a portion of each bend portion 28, 30 can extend at an oblique angle relative to the first straight portion 24 and/or the second straight portion 26. For example, the portion of the outer surface 40 and define an arcuate surface 42 engaged by the belt 16 forming an arcuate shape of each of the bend portions 28, 30. In this way, the first bend portion 28 can engage the body 38 of the first endplate 12a continuously between the first straight portion 24 and the second straight portion 26, and the second bend portion 30 can engage the body 38 of the second endplate 12b continuously between the first straight portion 24 and the second straight portion 26. The curve of the outer surface 40 and the belt 16 can provide enhanced clamping force.

The first and second endplates 12a, 12b can each define a plurality of passages 44 offset lengthwise from one another for receiving the plurality of belts 16. Each passage 44 can form at least a portion of the arcuate surface 42 recessed therein. A width of the passage 44 (extending in a direction of the length L of the battery assembly 10) can be within 5% or 10% of a width (extending in a direction of the length L of the battery assembly 10) of the belt 16. In some examples, the width of the passage 44 is less than 2% of the width of the belt 16. The passage 44 can align the belt 16 in the length-wise direction of the battery assembly 10, such that each belt 16 is retained from sliding along the body 38 outside of the passage 44.

With continued reference to FIGS. 1-3, the body 38 can include a pair of open curved portions 46 interposed by a raised portion 45. The raised portion 45 extends in a direction of the height and defines the passage 44. The open curved portions 46 and the passage 44 can together form the arcuate surface 42 that the belt 16 engages.

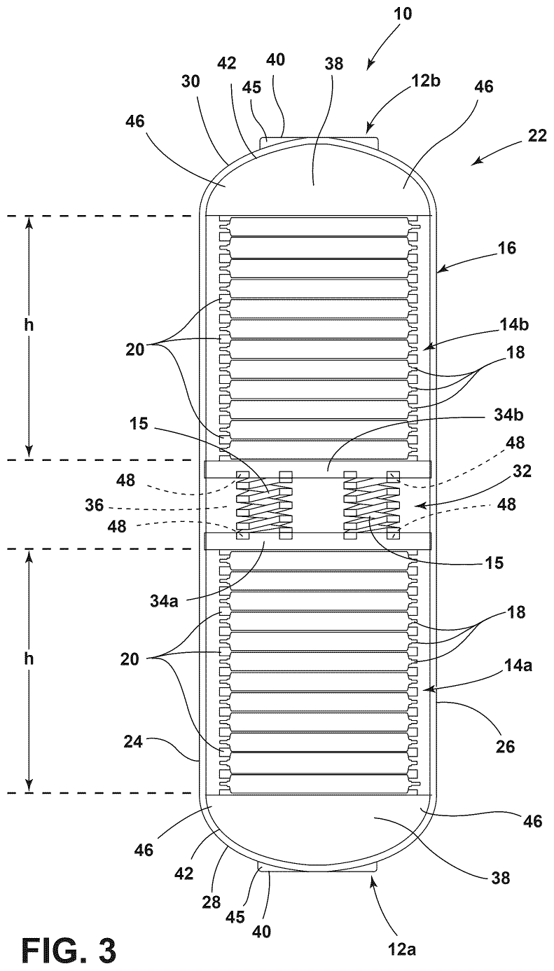

Referring particularly now to FIG. 3, the compression assembly 32 includes at least one alignment feature for aligning the compression springs 15 in the space 36. For example, each of the pair of retention plates 34a, 34b can define a groove 48 that is configured to receive an end of a compression spring 15. By way of example, the groove 48 can be annular for receiving an annular portion of a cylindrically-shaped compression spring 15. Each groove 48 can laterally align the spring.

In operation, the tension belt system 22 applies contact pressure within the battery assembly 10. As the cells 18 swell, they compress the retention plates 34a, 34b and thus compress the compression springs 15. The compression springs 15 thereby provide a spring force against the retention plates 34a, 34b and therefore the cell stacks 14a, 14b to maintain contact within each cell stack 14, 14b.

The battery assembly 10 can provide for a compact on-board vehicle module design. The curved endplates 12a, 12b can minimize bending stresses applied to cells 18 during compression to provide a uniform pressure distribution within the cell stacks 14a, 14b. In some aspects, the battery assembly 10 can provide for enhanced energy density via the use of solid-state batteries. The battery assembly 10 can provide for stack height h expansion (e.g., an increased number of cells 18 per cell stack 14, 14b).

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

10 battery assembly
12a first endplate
12b second endplate
14a first cell stack
14b second cell stack
15 compression spring
16 belt
18 cell
h stack height
20 compliant material
H height
L length
W width
22 tension belt system
24 first straight portion
26 second straight portion
28 first bend portion
30 second bend portion
32 compression assembly
34a first retention plate
34b second retention plate
36 space
38 body
40 outer surface
42 arcuate surface
44 passage
45 raised portion
46 open curved portion
48 groove

What is claimed is:

1. A battery assembly, comprising:
a first endplate;
a second endplate;
at least one cell stack disposed between the first endplate and the second endplate;
at least one compression spring disposed between the first endplate and the second endplate and configured to bias the at least one cell stack toward the second endplate; and
a belt operably coupled with and extending between the first endplate and the second endplate, the belt configured to bias the second endplate toward the first endplate.

2. The battery assembly of claim 1, wherein the at least one cell stack includes a plurality of cells stacked together forming a height of the at least one cell stack, wherein the belt includes a first straight portion, a second straight portion opposite the first straight portion, a first bend portion between the straight portions and extending around the first endplate, and a second bend portion between the straight portions and extending around the second endplate, wherein the belt is in tension to squeeze the at least one compression spring and the at least one cell stack together.

3. The battery assembly of claim 2, wherein the first endplate includes a body having an outer surface, at least a portion of which contacts the belt to form the first bend portion around the body, at least a portion of the first bend portion extending at an oblique angle relative to the first straight portion.

4. The battery assembly of claim 3, wherein the portion of the outer surface forms an arcuate surface engaged by the belt forming an arcuate shape of the first bend portion.

5. The battery assembly of claim 4, wherein the first endplate defines a passage forming at least a portion of the arcuate surface recessed therein.

6. The battery assembly of claim 4, wherein the arcuate surface extends from a first side of the body engaged by the first straight portion to a second side of the body engaged by the second straight portion.

7. The battery assembly of claim 1, comprising:
at least one retention plate disposed between the at least one cell stack and the at least one compression spring, the at least one retention plate configured to laterally align the at least one compression spring.

8. The battery assembly of claim 7, wherein the at least one retention plate includes a first retention plate and a second retention plate that sandwich the at least one compression spring.

9. The battery assembly of claim 8, wherein the at least one compression spring includes a plurality of compression springs disposed in a space defined between the first retention plate and the second retention plate, wherein the plurality of compression springs are laterally offset from one another.

10. The battery assembly of claim 8, wherein the at least one cell stack includes a first cell stack interposing the first endplate and the first retention plate and a second cell stack interposing the second endplate and the second retention plate.

11. The battery assembly of claim 7, wherein the at least one retention plate defines a groove configured to receive the at least one compression spring.

12. A battery assembly comprising:
a first endplate;
a second endplate;
at least one cell stack disposed between the first endplate and the second endplate;
at least one compression spring disposed between the first endplate and the second endplate and configured to bias the at least one cell stack toward the second endplate;
a retention plate disposed between the at least one cell stack and the at least one compression spring, the retention plate configured to align the at least one compression spring; and
a belt operably coupled with and extending between the first endplate and the second endplate, the belt configured to bias the second endplate toward the first endplate.

13. The battery assembly of claim 12, wherein the at least one cell stack includes a plurality of cells stacked together forming a height of the at least one cell stack, wherein the belt includes a first straight portion, a second straight portion opposite the first straight portion, a first bend portion between the straight portions and extending around the first endplate, and a second bend portion between the straight portions and extending around the second endplate, wherein the belt is in tension to squeeze the at least one compression spring and the at least one cell stack together.

14. The battery assembly of claim 13, wherein the first endplate includes a body having an outer surface, at least a portion of which contacts the belt to form the first bend portion around the body, at least a portion of the bend extending at an oblique angle relative to the first straight portion.

15. The battery assembly of claim 14, wherein the portion of the outer surface defines an arcuate surface engaged by the belts forming an arcuate shape of the first bend portion.

16. The battery assembly of claim 12, wherein the at least one cell stack includes a first cell stack interposing the first endplate and the retention plate.

17. A battery assembly, comprising:
first and second endplates;
a plurality of battery cells stacked between the first and second endplates;
at least one compression spring disposed within the plurality of battery cells; and
a tension belt system wrapped around the first and second endplates.

18. The battery assembly of claim 17, comprising:
spring retention plates distributed within the plurality of battery cells, wherein the at least one compression spring is disposed between two of the spring retention plates.

19. The battery assembly of claim 17, wherein the endplates are curved.

20. The battery assembly of claim 19, wherein compliant material is slotted between a pair of the plurality of battery cells.
